(19) United States
(12) Patent Application Publication
(10) Pub. No.: US 2015/0200899 A1
(43) Pub. Date: Jul. 16, 2015

(54) AUTOMATIC EMAIL REMINDER SYSTEM BASED ON MACHINE LEARNING

(71) Applicant: Google Inc., Mountain View, CA (US)

(72) Inventor: Pannag Raghunath SANKETI, Mountain View, CA (US)

(21) Appl. No.: 13/753,219

(22) Filed: Jan. 29, 2013

(51) Int. Cl. H04L 12/58

(52) U.S. Cl. CPC H04L 51/24

(57) ABSTRACT

Systems and methods which can determine email importance for a user, determine the urgency of a response to a given email, and suggest that the user review important and/or time-sensitive email at appropriate and convenient times for the user are provided. A user may also request a prioritized list of emails. Several factors are used to determine which email should be presented to a user. Email importance factors identify emails which are important to a user and email urgency factors identify emails which should be given more immediate attention. Additionally, time-appropriate factors are used to determine the appropriate time to present identified emails to the user.

### BACKGROUND

Email, or electronic mail, is a powerful communication tool that allows information to be exchanged nearly instantaneously. However, the ease of sending email can result in a recipient receiving so many emails that he or she has a very hard time reading and responding to all of the messages at a given time. Some unread email messages may be important or require an immediate response from the recipient.

Conventional methods for handling email that is unread or to which a response has not been given usually require a recipient to take manual action such as flagging an email as important or unread in order for the email to be easily identified.

In customary systems, users may also use folders to categorize and organize email. Although an email can be categorized and marked as important using customary and conventional methods, there is not an easy way to rank the importance of an email in relation to the total number of email messages requiring a response Important email messages are not all equal in their importance or in the time-sensitivity of a response. If a user has limited time to review email, he or she may want to review the most important or the most urgent messages first. Conventional systems require a user to manually find important and urgent emails to review.

As recognized by the inventor, there should be an automated system for classifying email by importance and time-sensitivity and for reminding users of important email that has either not been read or to which a response has not been given. A user should not have to worry about always manually classifying important email messages or finding the messages at a later date. The automated system should send users reminders regarding important and urgent email at convenient times for the user to review email so that the user can read and respond to the email.

### SUMMARY

This specification describes technologies relating to machine learning and email classification in general, and specifically to methods and systems for creating an automatic email reminder system based on machine learning.

In general, one aspect of the subject matter described in this specification can be embodied in a system and method for generating reminders regarding electronic mail that is unread or to which a user has not yet responded. An exemplary system includes: one or more processing devices and one or more storage devices storing instructions that, when executed by the one or more processing devices, cause the one or more processing devices to receive a plurality of electronic mail, identify each electronic mail's importance using electronic mail importance factors, identify a relative urgency of electronic mail based on electronic mail urgency factors, identify an appropriate time for the user to respond to identified electronic mail using time-appropriate factors, and suggest that the user read or respond to identified electronic mail during the identified appropriate time. A second exemplary system includes: one or more processing devices and one or more storage devices storing instructions that, when executed by the one or more processing devices, cause the one or more processing devices to receive a request to review electronic mail, prioritize electronic mail using electronic mail importance factors, prioritize electronic mail based on urgency factors, and display prioritized electronic mail. An exemplary method includes: receiving a plurality of electronic mail, identifying each electronic mail's importance using electronic mail importance factors, identifying a relative urgency of electronic mail based on electronic mail urgency factors, identifying an appropriate time for the user to respond to identified electronic mail using time-appropriate factors, and suggesting that the user read or respond to identified electronic mail during the identified appropriate time.

These and other embodiments can optionally include one or more of the following features: an importance factor may be based on an electronic mail sender's identity, an importance factor may be based on an electronic mail subject, an importance factor may be based on the number of emails received from a specific sender in a given time period, an electronic mail urgency factor may be based on whether the electronic mail's content includes a deadline, an electronic mail urgency factor may be based on whether the sender has previously emailed regarding substantially the same subject, an electronic mail urgency factor may be based on the amount of time between when an electronic mail was sent and the current date and/or time, an electronic mail time-appropriate factor may be based on a recipient's current time of day, an electronic mail time-appropriate factor may be based on a recipient's current location, an electronic mail time-appropriate factor may be based on a recipient's current activities, and electronic mail may be identified using time-appropriate factors before displaying the electronic mail.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a flow diagram of an exemplary method for creating an automatic email reminder system based on machine learning.

FIG. 2 is a flow diagram of an exemplary method for creating a prioritized email display.

FIG. 3 is a flow diagram of an exemplary method for creating a prioritized email display.

FIG. 4 is a block diagram illustrating an exemplary computing device.

### DETAILED DESCRIPTION

According to an exemplary embodiment, an automated system can determine email importance for a user, determine the urgency necessary for a response to a given email, remind the user about important and/or time-sensitive email, and suggest that the user review the email at appropriate and convenient times for the user. The automated system may run on a computing device.

Email importance can be determined by using specific criteria, or electronic mail importance factors. An exemplary system may allow a user to specify his or her own criterion for determining email importance or the system may choose default factors. Such factors may include: the email's sender; the email's recipient(s); the email's subject; and the number of emails received regarding the email's subject or from the email's sender. In some embodiments, an email recipient may manually indicate that an email is important using an email client application to flag the email by certain factors including: important, unread, or urgent.

A recipient can also designate certain email topics to be of high importance. An email may be designated as important based on the recipient's behavior with respect to emails having the same or similar characteristics or emails related to the email.

An exemplary system may be taught which emails are important to a user based on certain user preferences or other factors. For example, a user may typically respond right away to emails with specific senders such as emails from a boss or a family member. An exemplary system may therefore designate all emails received from the recipient's boss or family members as important. In some embodiments, a user may label an email address with an identifying label such as “boss,” “sister,” “co-worker,” or “spouse.” In other embodiments, a system can use user behavior such as responding right away as clues to learn which senders are important to a given user.

An exemplary system may also use a user's search history or user social signals to determine important emails. For example, if a user performs several searches on a particular topic, like photography, any emails related to that topic may be considered important. A user may also belong to a social networking group related to a particular topic. Any email from people in the social network group may be given higher priority over other email.

As another example, a user may typically move all messages sent by a specific store such as a sporting goods store from his or her inbox to the trash. Based on this user behavior, an exemplary system may designate all emails received by the store as not important or as having very low importance. Users may create rules, use labels, star email, or use some other mechanism for indicating that an email is important to them.

In an exemplary system, a model may be created and refined that emulates user behavior/response to email messages and prioritizes email based on this response. An exemplary system may use machine learning to model user behavior. An initial model of importance may be created using rules based on large-scale data collection. A small number of users may be used to test email importance rules. Users may be shown pairs of emails and asked to vote on which email in the pair they consider to be more important. After the creation of an initial model, an exemplary system may observe user behavior with respect to specific email metrics. The exemplary system may modify weight it gives to each model parameter based on user behavior.

This system may learn trends that a user follows on social networking sites. The system may additionally or alternatively learn the topics about which a user normally posts about on social networking sites. These search, followed, or posted about topics may be considered important to a user. Therefore, email associated with these topics or with people who are in the same or similar social networking groups as the user may be considered highly important. It should be noted that email topic priority may change over time.

In some embodiments, a system may recognize an email as part of an email chain for an important project or as email related to a calendar event based factors such as the subject or contents of the email. Email importance factors can be applied to email when the email is first received by an exemplary system. Factors can also be applied at a later time as more data for the user is collected.

In addition to determining email importance, an exemplary system may identify emails that are time-sensitive or that need an immediate response. For example, a user may receive an email from the Department of Motor Vehicles (DMV) reminding the user to renew his registration before the registration expiration date, which is three months from the date that the reminder was mailed. Although the email topic may be important to the user because the user needs to renew his registration, the email does not need immediate attention because the registration does not expire for three months. However, the user may have another email in his inbox inviting him to a party that will occur in two days. Although an email about a party may be only moderately important to the user compared to an email from the DMV, the email requires a more urgent response since the party is in two days.

An exemplary system may use urgency factors to determine time-sensitivity or emails that require immediate attention. Urgency factors may include: whether an email's contents mention a deadline; the topic of an email; whether an email's sender has already emailed; whether an email is for an event in which an RSVP is required or a date is mentioned; and the amount of time between the date on which an email was sent and the current date.

Urgency factors may be determined when an email is received by an exemplary system. Factors may also be determined when the system is deciding which emails to show to a user at a given time. For example, an email may have been received five days ago and the email discusses a meeting that will occur tomorrow. Five days ago when the email was received the email may have not been urgent. However, if the email is still unread or no response has been sent as of the current date, the system may suggest that the user respond to email today.

An exemplary system may also identify appropriate and/or convenient times for a user to read and respond to email using convenience factors. Convenience factors may include: the time of day; the user's current location; the user's available amount of free time; and the activities the user is currently undertaking. These factors may be determined using a user's smartphone or other electronic device. The user's location may be determined by location technologies including global positioning system (GPS), near field communication (NFC), or WiFi. These technologies may be able to determine a user's physical location in terms of longitude and latitude coordinates. An exemplary system may use learned semantic labels associated with physical coordinates to decide what the coordinates mean for the user. Learned semantic location labels may include: “home,” “office,” “shuttle stop,” or “gym.” An exemplary system may then be able to provide venue-appropriate emails for the user. In other embodiments, learned semantic labels may be associated with time periods including: “lunch,” “leisure,” “meeting,” and “event.” An exemplary system may be able to provide time-appropriate emails for the user based on these labels. Semantic labels associated with time or places can be learned by the system based on available techniques and technologies.

An exemplary system may use additional information from a user's smartphone or other electronic device to further inform the decision about appropriate emails to display to a user at a given time. An accelerometer, a gyroscope, or other sensor values may help the system identify user activities such as running, walking, or other physical movements. An exemplary system may be taught to understand other miscellaneous signals associated with a user including the user's daily routine, whether the user prefers to read email between or at certain activities or events, and whether a user is waiting for transportation, commuting, or operating a motor vehicle.

An exemplary system may learn a user's trends and may be able to automatically suggest email based on these trends. For example, a user may maintain a TODO label for email and may check emails under that label. The user may then pick an email or two and reply to them during a specific time period like after lunch or in between meetings. The exemplary system may learn these trends and automatically suggest email' after lunch or in between meetings.

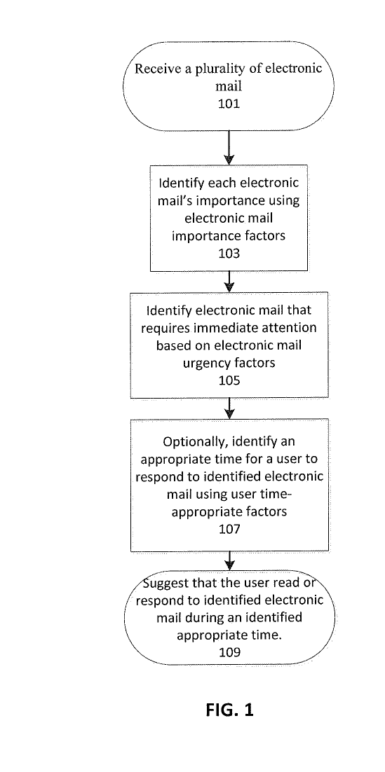

An exemplary method as illustrated in FIG. 1 begins with receiving a plurality of electronic mail (101). Using the factors discussed above, emails can be identified that are important to a user (103). Email requiring immediate attention can also be identified based on urgency factors (105). Appropriate times for the user to review email can optionally be identified using time-appropriate factors (107). The system can therefore suggest emails at appropriate times that the user can read or to which the user can respond (109). In addition to the previously-described criteria for choosing emails for a user, an exemplary system may consider other factors when determining the emails to suggest to a user including: the likelihood of an email requiring a user's attention immediately; the time required to read or respond to the email; the likelihood a user will accept the suggestion to give attention to a particular email; and how an email may be combined with other email conversations. In some embodiments, an exemplary system may make email recommendations to a user which maximize the likelihood that the user will respond to the email task that the system recommends. In other embodiments, an exemplary system may recommend that a user respond to the content of an email via instant messaging, text messaging, by calling a person, or using some other form of communication instead of email based on situational factors or the user's or recipients preferences.

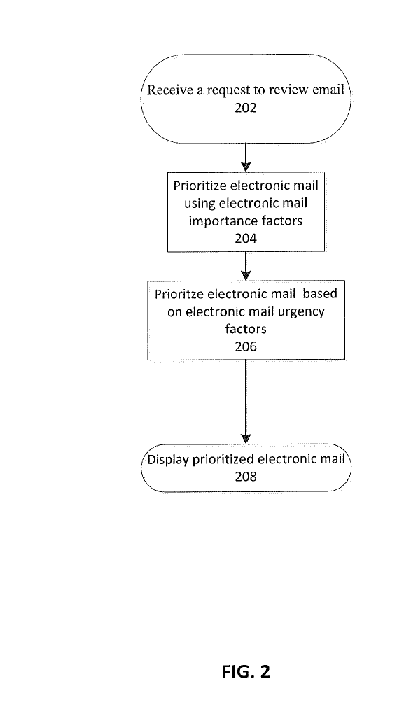

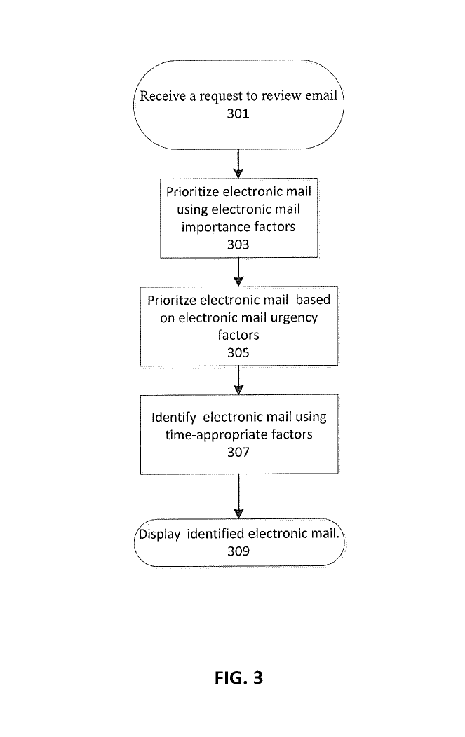

In some embodiments, a user may request email to review instead of waiting for a system to suggest email as illustrated in FIG. 2. An exemplary method begins with receiving a request to review email (202). The email is prioritized using electronic mail importance factors (204) and electronic mail urgency factors (206). The prioritized email is then displayed to the requesting user (208). Before displaying the email to a user, a system may identify appropriate email for the user based on time-appropriate factors as shown in FIG. 3 (307).

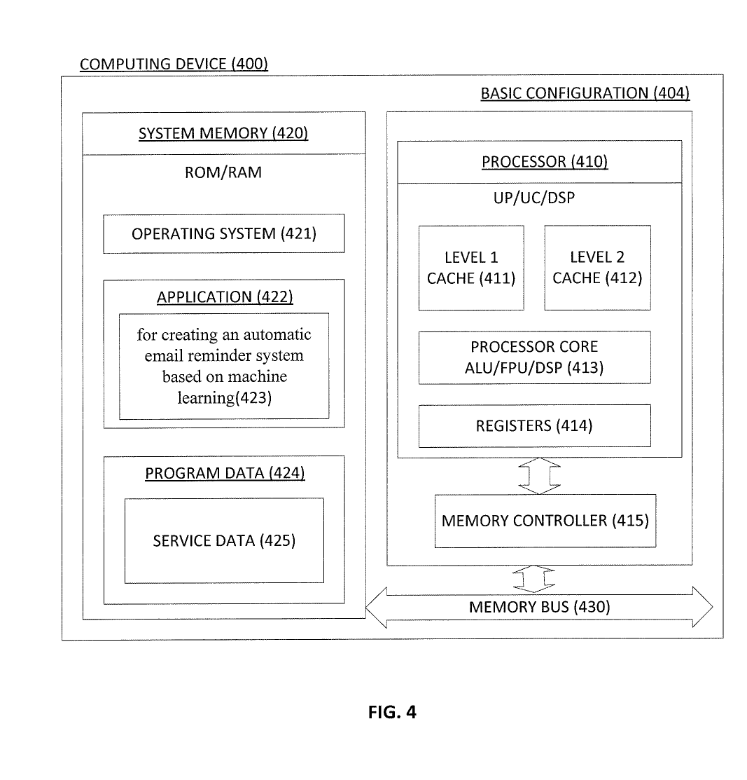

FIG. 4 is a block diagram illustrating an example computing device (400) that is arranged for running an automated system that recommends email to a user for review. In a very basic configuration (401), the computing device (400) typically includes one or more processors (410) and system memory (420). A memory bus (430) can be used for communicating between the processor (410) and the system memory (420).

Depending on the desired configuration, the processor (410) can be of any type including but not limited to a microprocessor (μP), a microcontroller (μC), a digital signal processor (DSP), or any combination thereof. The processor (410) can include one more levels of caching, such as a level one cache (411) and a level two cache (412), a processor core (413), and registers (414). The processor core (413) can include an arithmetic logic unit (ALU), a floating point unit (FPU), a digital signal processing core (DSP Core), or any combination thereof. A memory controller (416) can also be used with the processor (410), or in some implementations the memory controller (415) can be an internal part of the processor (410).

Depending on the desired configuration, the system memory (420) can be of any type including but not limited to volatile memory (such as RAM), non-volatile memory (such as ROM, flash memory, etc.) or any combination thereof. System memory (420) typically includes an operating system (421), one or more applications (422), and program data (424). The application (422) may include a method for synchronous collaborative scheduling. Program Data (424) includes storing instructions that, when executed by the one or more processing devices, implement a system and method for creating an automatic email reminder system based on machine learning. (423). In some embodiments, the application (422) can be arranged to operate with program data (424) on an operating system (421).

The computing device (400) can have additional features or functionality, and additional interfaces to facilitate communications between the basic configuration (401) and any required devices and interfaces.

System memory (420) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media can be part of the device (400).

The computing device (400) can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device (400) can also be implemented as a personal computer including both laptop computer and non-laptop computer configurations.

In situations in which the system discussed here collects personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the server that may be more relevant to the user. In addition, certain data may be treated in one or more ways before it is stored or used so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A system generating reminders regarding electronic mail that is unread or to which a user has not yet responded, the system comprising:
one or more processing devices; and
one or more storage devices storing instructions that, when executed by the one or more processing devices, cause the one or more processing devices to:
model a specific user's behavior based on the user's interaction with electronic mail and either the user's search history or the user's social signals using machine learning;
receive a plurality of electronic mail;
identify each electronic mail's importance using electronic mail importance factors based on the modeled specific user behavior;
identify a relative urgency of electronic mail based on electronic mail urgency factors determined by the modeled specific user behavior and time-sensitivity;
identify an appropriate time for the user to respond to identified electronic mail using time-appropriate factors determined by the modeled specific user behavior; and
suggest that the user read or respond to identified electronic mail during the identified appropriate time.

2. The system of claim 1 wherein at least one of the electronic mail importance factors is based on an electronic mail sender's identity and the modeled specific user behavior for handling electronic mail from the sender.

3. The system of claim 1 wherein at least one of the electronic mail importance factors is based on an electronic mail subject and the modeled specific user behavior for handling electronic mail with the subject.

4. The system of claim 1 wherein at least one of the electronic mail importance factors is based on the number of emails received from a specific sender in a given time period and the modeled specific user behavior for handling electronic mail from the specific sender in a given time period.

5. The system of claim 1 wherein at least one electronic mail urgency factors is based on whether the electronic mail's content includes a deadline and the modeled specific user behavior for handling electronic mail with a deadline.

6. The system of claim 1 wherein at least one of the electronic mail urgency factors is based on whether the sender has previously emailed regarding substantially the same subject and the modeled specific user behavior for handling electronic mail with substantially the same subject from the same sender.

7. The system of claim 1 wherein at least one of the electronic mail urgency factors is based on the amount of time between when an electronic mail was sent and the current date and/or time and the modeled specific user behavior for handling electronic mail based on an elapsed time.

8. The system of claim 1 wherein at least one of the electronic mail time-appropriate factors is based on a recipient's current time of day and the modeled specific user behavior for handling electronic mail at the current time of day.

9. The system of claim 1 wherein at least one of the electronic mail time-appropriate factors is based on a recipient's current location and the modeled specific user behavior for handling electronic mail at the current location.

10. The system of claim 1 wherein at least one of the electronic mail time-appropriate factors is based on a recipient's current activities and the modeled specific user behavior for handling electronic mail at the current location.

11. A system for prioritizing electronic mail that is unread or to which a user has not yet responded, the system comprising:
one or more processing devices; and
one or more storage devices storing instructions that, when executed by the one or more processing devices, cause the one or more processing devices to:
model specific user behavior based on the user's interaction with electronic mail and either the user's search history or the user's social signals using machine learning;
receive a request to review electronic mail;
prioritize electronic mail using electronic mail importance factors based on modeled specific user behavior;
prioritize electronic mail based on urgency factors based on modeled specific user behavior and time-sensitivity; and
display prioritized electronic mail.

12. The system of claim 11 further comprising identifying electronic mail using time-appropriate factors before displaying prioritized electronic mail.

13. A computer-implemented method for generating reminders regarding electronic mail that is unread or to which a user has not yet responded comprising:
modeling specific user behavior based on the user's interaction with electronic mail and either the user's search history or the user's social signals using machine learning;
receiving a plurality of electronic mail;
identifying each electronic mail's importance using electronic mail importance factors based on modeled specific user behavior;
identifying a relative urgency of electronic mail based on electronic mail urgency factors determined by modeled specific user behavior and time-sensitivity;
identifying an appropriate time for the user to respond to identified electronic mail using time-appropriate factors determined by modeled specific user behavior; and
suggesting that the user read or respond to identified electronic mail during the identified appropriate time.

14. The method of claim 13 wherein at least one of the electronic mail importance factors is based on an electronic mail sender's identity and the modeled specific user behavior for handling electronic mail from the sender.

15. The method of claim 13 wherein at least one of the electronic mail importance factors is based on an electronic mail subject and the modeled specific user behavior for handling electronic mail with the subject.

16. The method of claim 13 wherein at least one of the electronic mail importance factors is based on the number of emails received from a specific sender in a given time period and the modeled specific user behavior for handling electronic mail from the specific sender in a given time period.

17. The method of claim 13 wherein at least one electronic mail urgency factors is based on whether the electronic mail's content includes a deadline and the modeled specific user behavior for handling electronic mail with a deadline.

18. The method of claim 13 wherein at least one of the electronic mail urgency factors is based on whether the sender has previously emailed regarding substantially the same subject and the modeled specific user behavior for handling electronic mail with substantially the same subject from the same sender.

19. The method of claim 13 wherein at least one of the electronic mail urgency factors is based on the amount of time between when an electronic mail was sent and the current date and/or time and the modeled specific user behavior for handling electronic mail based on an elapsed time.

20. The method of claim 13 wherein at least one of the electronic mail time-appropriate factors is based on a recipient's current time of day and the modeled specific user behavior for handling electronic mail at the current time of day.

21. The method of claim 13 wherein at least one of the electronic mail time-appropriate factors is based on a recipient's current location and the modeled specific user behavior for handling electronic mail at the current location.

22. The method of claim 13 wherein at least one of the electronic mail time-appropriate factors is based on a recipient's current activities and the modeled specific user behavior for handling electronic mail at the current location.
